(19) United States
(12) Patent Application Publication
(10) Pub. No.: US 2007/0280677 A1
(43) Pub. Date: Dec. 6, 2007

(54) Auxiliary lens attachment for cellular telephones

(76) Inventors: Marc Thomas Drake, San Diego, CA (US); Tony Dowdell, San Diego, CA (US)

Correspondence Address: Donald W. Meeker, 924 East Ocean Front #E, Newport Beach, CA, 92661, US

(21) Appl. No.: 11/443,391

(22) Filed: May 30, 2006

(51) Int. Cl. G03B 19/00

(52) U.S. Cl. 396/429; 396/533

(57) ABSTRACT

An auxiliary photographic lens and lens holder bracket for an existing portable cellular phone having a camera function therein. The square U-shaped lens holder bracket straddles the body of the cellular phone positioning the auxiliary lens over the built-in camera lens of the existing cellular telephone. The lens cylinder has a threaded end which screws into a threaded opening in the front of the bracket and against the cell phone case around the built-in lens to secure the lens to the cell phone. The lens holder alternately serves as a protective storage device for the lens when it is not in use with the lens cylinder screwed into the cross piece of the bracket. The lens may be a telephoto lens, a wide angle lens, a filter, or alternately a zoom or adjustable lens.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to attachments for cameras, and particularly to a attachable and removable lens and lens holder for a portable cellular phone having a camera function therein; the lens holder clips over the body of the cell phone positioning the auxiliary lens over the camera lens of the telephone, the lens may be a telephoto lens, a wide angle lens, a zoom lens, or alternately a filter.

2. Description of Related Art Including Information Disclosed under 37 CFR 1.97 and 1.98

Cell phones now can come equipped with a digital photo picture taking capability with the camera lens on the outside of the case. The lens is built into the case and has no adjustment capability for distance and no focus capability. Prior art devices fail to provide an adjustable or telephoto lens attachable to and removable from a cell phone camera that would be convenient to carry and easily be installed on the cell phone.

Prior art U.S. Pat. No. 6,967,790, issued Nov. 22, 2005 to Wei, claims a detachable zoom lens assembly that is detachably connectable to a digital camera, camera mobile phone, or any of a variety of apparatus with photographic function.

Prior art U.S. Pat. No. 6,889,006, issued May 3, 2005 to Kobayashi, is for an auxiliary lens such as a conversion lens or a filter used for cameras and products with a built-in camera including a cellular phones with a built-in camera. The auxiliary lens includes an auxiliary-lens body and a washer connected to the auxiliary-lens body at one end face and mounted to a camera and the like at the other end and being capable of connection between the washer and the auxiliary-lens body by a magnetic force.

Prior art U.S. Pat. No. 3,747,490, issued Jul. 24, 1973 to Brandt, provides a lens accessory holder for a camera. The holder comprises a wide band having, at each end, a backwardly extending arm having a detent. The accessory holder is made from a springy material so that it will snap onto the camera's shutter housing, and comes off by urging the arms apart slightly so that the detents disengage from the shutter housing. The accessory holder has a hole at the center of the band for holding a lens in front of the cameras lens. The lens may be a filter, a macro lens, or other lens accessory.

Prior art U.S. Pat. No. 2,970,509, issued Feb. 7, 1961 to Barthruff, shows a camera viewfinder attachment for varying the field of view. The viewfinder attachment comprises a lens mounted in a band-shaped mounting member having, at each end, a backwardly extending arm having a hook-member. The accessory holder is made from a flexible material so that it will snap onto the camera's shutter housing, and comes off by urging the arms apart slightly so that the hooks disengage from the shutter housing.

Prior art U.S. Pat. No. 3,961,349, issued Jun. 1, 1976 to Forsyth, describes an accessory mounting adaptor for a camera. The attachment serves to mount accessories such as auxiliary portrait, wide-angle, or telephoto lenses, filter lenses for the camera's objective lens and photocell, auxiliary shutter or control knobs, and flash equipment, in aligned operative relation to the corresponding elements of the camera. The attachment comprises a housing mounting the accessories in a front portion, and a pair of wing portions extending rearwardly to embrace the side walls of the lens-shutter housing, and bearing a pair of opposed latch portions which releasably engage rear corner portions of the side walls. Locating flanges in the side walls of the lens-shutter housing align the attachment correctly with the camera. A pair of actuating levers' may be connected with the latch portions and extended forwardly of the housing into opposed grip portions for manual deflection of the latch portions to disengage the attachment from the camera.

Prior art U.S. Pat. No. 6,947,571 issued Sep. 20, 2005 to Rhoads, discloses cell phones with optical capabilities, and related applications. A cell phone is equipped with a 2D optical sensor, enabling a variety of applications. For example, such a phone may also be provided with a digital watermark decoder, permitting decoding of steganographic data on imaged objects. Movement of a phone may be inferred by sensing movement of an imaged pattern across the optical sensor's field of view, allowing use of the phone as a gestural input device through which a user can signal instructions to a computer-based process. A variety of other arrangements by which electronic devices can interact with the physical world are also detailed, e.g., involving sensing and responding to digital watermarks, bar codes, RFIDs, etc. In other embodiments, the camera (or other sensor) can be equipped with one or more auxiliary fixed-focus lenses that can be selectively used, depending on the particular application. Some such embodiments have a first fixed focused lens that always overlies the sensor, with which one or more auxiliary lenses can be optically cascaded (e.g., by hinge or slide arrangements). Such arrangements are desirable, e.g., when a camera is not a dedicated Bedoop sensor but also performs other imaging tasks. When the camera is to be used for Bedoop, the auxiliary lens is positioned (e.g., flipped into) place, changing the focal length of the first lens (which may by unsuitably long for Bedoop purposes, such as infinity) to an appropriate Bedoop imaging range (such as one foot).

Prior art U.S. Patent Application #20050213790 published Sep. 29, 2005 by Rhoads, relates cell phones with optical capabilities, and related applications. A cell phone is equipped with a 2D optical sensor, enabling a variety of applications. For example, such a phone may also be provided with a digital watermark decoder, permitting decoding of steganographic data on imaged objects. Movement of a phone may be inferred by sensing movement of an imaged pattern across the optical sensor's field of view, allowing use of the phone as a gestural input device through which a user can signal instructions to a computer-based process. A variety of other arrangements by which electronic devices can interact with the physical world are also detailed, e.g., involving sensing and responding to digital watermarks, bar codes, RFIDs, etc. In other embodiments, the camera (or other sensor) can be equipped with one or more auxiliary fixed-focus lenses that can be selectively used, depending on the particular application. Some such embodiments have a first fixed focused lens that always overlies the sensor, with which one or more auxiliary lenses can be optically cascaded (e.g., by hinge or slide arrangements). Such arrangements are desirable, e.g., when a camera is not a dedicated Bedoop sensor but also performs other imaging tasks. When the camera is to be used for Bedoop, the auxiliary lens is positioned (e.g., flipped into) place, changing the focal length of the first lens (which may by unsuitably long for Bedoop purposes, such as infinity) to an appropriate Bedoop imaging range (such as one foot).

What is needed is an adjustable or telephoto lens attachable to and removable from a cell phone camera that would be convenient to carry and easily be installed on the cell phone.

### BRIEF SUMMARY OF THE INVENTION

An object of the present invention is to provide an attachable photographic lens to fit a wide variety of cell phones with cameras including adjustable and/or telephoto or close-up lenses attachable to and removable from a cell phone camera that would be convenient to carry and easily be installed on the cell phone.

A related object of the present invention as to provide a square U-shaped bracket or frame which fits over the cell phone centered on the camera lens of the cell phone and a screw-on portable photographic lens screwed through a threaded opening on the front of the bracket or frame centered on the cell phone camera lens, wherein the portable photographic lens is screwed through into contact with a face of the cell phone surrounding the camera lens on the cell phone to secure the portable photographic lens and bracket or frame removably on the cell phone so that the portable photographic lens alters the digital image as desired.

Another object of the present invention is to provide a threaded lens storage opening in the cross piece of the bracket or frame so that the portable photographic lens may be screwed into the lens storage opening with the bracket or frame shielding the portable photographic lens for storage or transport.

In brief, a square U-shaped bracket or frame which is removably positioned an a cell phone at the location of the digital camera lens with one leg on one side of the cell phone case and the other leg on the other side. A portable photographic lens has a threaded end with padding which screws through a front threaded opening in a front leg of the square U-shaped bracket or frame to align with a cell phone digital camera lens. The portable photographic lens is screwed into the threaded opening with the padded end of the portable photographic lens contacting the cell phone case surrounding the cell phone digital camera lens to secure the portable photographic lens and bracket or frame to the cell phone.

The U-shaped frame is provided with a lens storage threaded opening on the interior of the cross member between the legs. The threaded end of the lens cylinder may be secured within the lens storage opening, thereby protecting the lens within the legs of the U-shaped bracket or frame for storage or transport.

The purpose of the device is to provide an additional photographic lens to a cell phone digital camera for altering the focus of the camera.

An advantage of the present invention is that it is easily installed on a cell phone and easily removed.

Another advantage of the present invention is that the bracket or frame serves as a protective casing for transporting or storing the portable photographic lens when not in use on the cell phone.

A further advantage of the present invention is that it fits a wide variety of cell phones with cameras.

Yet another advantage of the present invention is that it inexpensively expands the capabilities of existing cell phone cameras.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a side elevational view taken in partial section through the center of the frame of the invention and showing the portable photographic lens of the invention mounted in the frame in a viewing position;

FIG. 2 is a side elevational view taken in partial section through the center of the frame of the invention and showing the portable photographic lens of the invention mounted in the frame in a storage position;

FIG. 3 is a side elevational view showing the portable photographic lens of the invention mounted in the frame and attached to a cell phone in the viewing position aligned with the built-in camera lens of the cell phone;

FIG. 4 is a side elevational enlarged view showing the portable photographic lens of the invention mounted in the frame and attached to a cell phone in the viewing position with the portable photographic lens of the invention aligned with the built-in camera lens of the cell phone;

FIG. 5 is a front elevational enlarged view showing the portable photographic lens of the invention mounted in the frame and attached to a cell phone in the viewing position with the portable photographic lens of the invention aligned with the built-in camera lens of the cell phone;

FIG. 6 is a side elevational enlarged view of the portable photographic lens of the invention;

FIG. 7 is a cross-sectional enlarged view taken through the centerline of the frame of the invention.

### DETAILED DESCRIPTION OF THE INVENTION

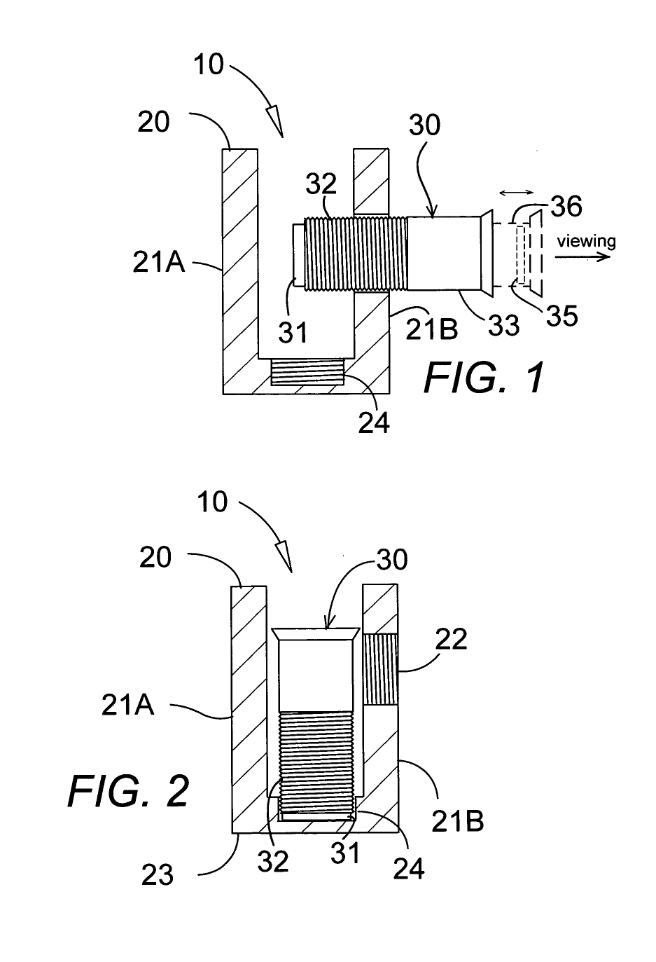

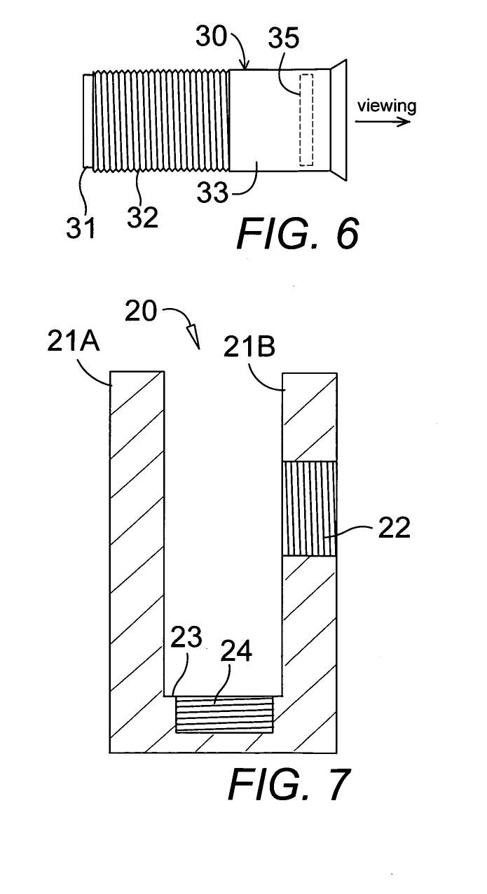

In FIGS. 1-7, a portable photographic lens device 10 mounts removably on a cell phone 40 having a digital camera with a built-in lens 45 with the portable photographic lens 35 aligned with the built-in lens 45 for modifying the digital image.

The device 10 comprises an attachable lens cylinder 30 with one or more photographic lenses 35 configured to modify an image viewed and digitally photographed through an existing built-in lens 45 on an existing cell phone 40.

The device 10 also comprises a means for removably attaching the attachable portable photographic lens 35 to a cell phone 40 having an existing built-in lens 45 for a built-in digital photography device in the cell phone 40, so that the attachable portable photographic lens 35 is aligned with the existing built-in lens 45 on the existing cell phone 40 to produce a desired digital photographic image modified by the attachable portable photographic lens 35.

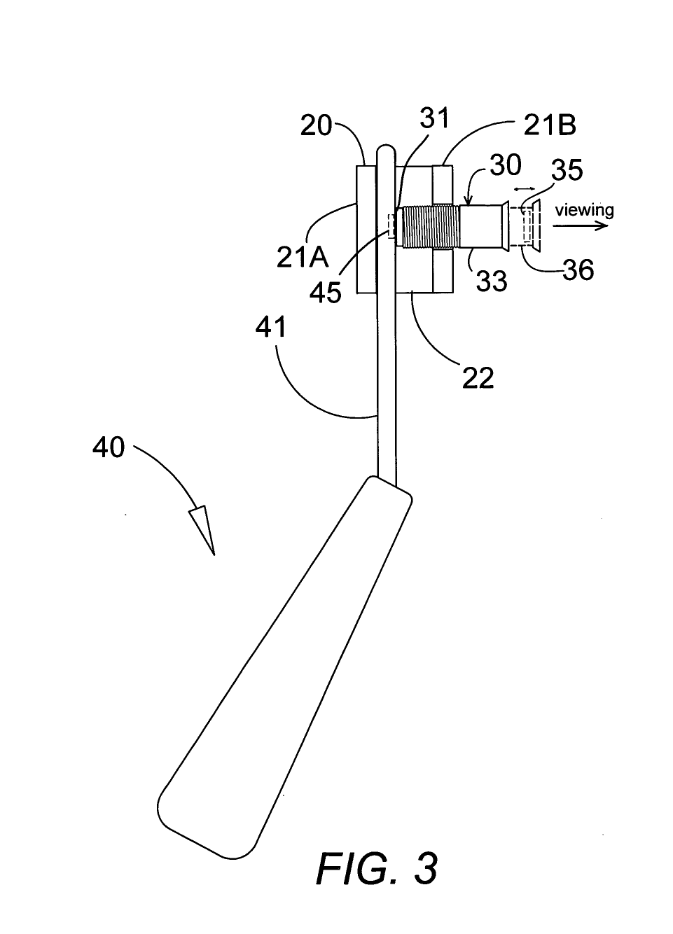

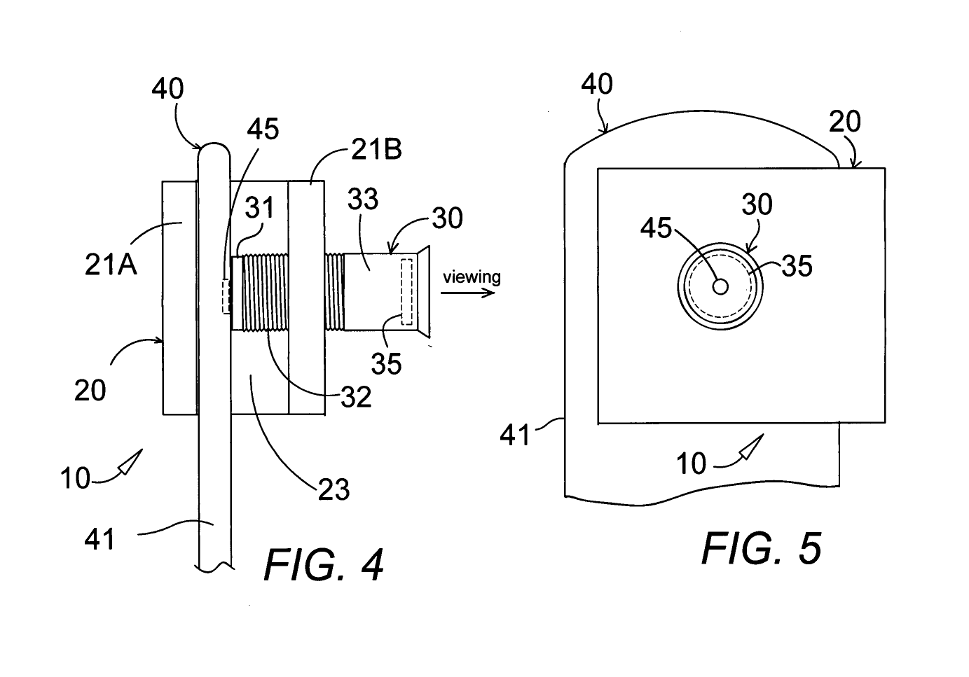

The means for removably attaching the attachable portable photographic lens 35 comprises a removable square U-shaped frame 20 which straddles the cell phone adjacent to the existing built-in lens 45. A first leg 21A of the square U-shaped frame 20 is positioned on a side of the cell phone 40 away from the built-in lens 45 and a second leg 21B of the U-shaped frame 40 positioned on the same side of the cell phone 40 as the built-in lens 45, as shown in FIGS. 3 and 4. The second leg 21B has a circular threaded opening 22 therethrough which centers over the existing photographic lens 45 of the camera. The attachable portable photographic lens 35 has a lens cylinder 30 with a smooth portion 33 and a threaded end portion 32 that mates with the threaded opening 22 so that the attachable portable, photographic lens cylinder 30 may (be screwed through the threaded opening 22 and into contact with an exterior of the cell phone case 41 surrounding the existing built-in lens 45 on the cell phone 40 so that the portable photographic lens cylinder 30 secures the frame 20 to the cell phone 40 and the attachable portable photographic lens 35 aligns with the existing built-in lens 45 on the cell phone 40, as shown in FIGS. 3, 4, and 5, to produce a digital camera image modified by the attachable lens 35. The threaded end 32 of the lens cylinder 30 has a padded edge 31 for contact with the cell phone case 41, as shown in FIGS. 3 and 4.

The two arms 21A and 21B of the U-shaped frame 20 are spaced apart by a distance greater than the width of the attachable lens cylinder 30. A cross member 23 between the two arms 21A and 21B of the frame 20 has a threaded lens storage hole 24 therein matching the threaded end 32 of the attachable lens cylinder 30 so that the attachable lens cylinder 30 screws into the threaded lens storage hole 24 for storing the attachable lens cylinder 30 in the frame 20 when not in use on the cell phone 40, as shown in FIG. 2.

The attachable portable photographic lens 35 may comprise a distance lens, a filter, a telephoto lens, a close-up lens, an adjustable focus lens 36, as shown in FIGS. 1 and 3, to focus the image over a range of distances or any other type of desired portable photographic lens 35 to meet the needs of the user.

In use, the U-shaped frame 20 straddles the cell phone 40 over the portion having a built-in camera lens 45. A first leg 21A of the U-shaped frame 20 is positioned on a side of the cell phone 40 away from the built-in lens 45 and a second leg 21B of the U-shaped frame 40 is positioned on the same side of the cell phone 40 as the built-in lens 45, as shown in FIGS. 3 and 4. The threaded end 32 of the lens cylinder 30 is then partially screwed into a threaded opening 22 in the second leg 21B of the frame 20. The lens 35 is aligned in a viewing position with the built-in lens 45 on the cell phone 40, and the lens cylinder 30 is screwed until the padded end 31 is tight against the cell phone case 41, thereby securing the frame 20 to the cell phone 40, as shown in FIGS. 3, 4 and 5.

For storage, the lens cylinder 30 is completely unscrewed from the first threaded opening 22 in the frame 20. The frame 20 is removed from the cell phone 40, and the threaded end 32 of the lens cylinder 30 is then screwed into a second threaded opening 24 in the cross piece 23 of the frame 20 so that the legs 21A and 21B of the U-shaped frame 20 protect the lens 35, as shown in FIG. 2.

The removably attachable portable photographic lens 35 may be a distance lens, a filter, a telephoto lens, a close-up lens, or an adjustable focus lens 36, as shown in FIGS. 1 and 3.

It is understood that the preceding description is given merely by way of illustration and not in limitation of the invention and that various modifications may be made thereto without departing from the spirit of the invention as claimed.

What is claimed is:

1. A photographic lens device for a cell phone having a camera, the device comprising:
an attachable portable photographic lens configured to modify an image viewed and digitally photographed through an existing built-in lens on an existing cell phone;
a means for removably attaching the attachable portable photographic lens to a cell phone having an existing built-in lens for a built-in digital photography device in the cell phone so that the attachable portable photographic lens is aligned with the existing built-in lens on the existing cell phone to produce a desired digital photographic image modified by the attachable portable photographic lens.

2. The device of claim 1 wherein the means for removably attaching the portable photographic lens to the cell phone comprises a square U-shaped frame removable straddling the cell phone adjacent to the existing built-in lens with a first leg of the square U-shaped frame positioned on a side of the cell phone away from the built-in lens and a second leg of the square U-shaped frame positioned on the same side of the cell phone as the built-in lens, the second leg having a circular threaded opening therethrough centered over the existing built-in lens of the camera in the cell phone and the attachable portable photographic lens having a lens cylinder with a threaded end portion mating the threaded opening in the second leg of the frame so that the attachable portable photographic lens may be screwed through the threaded opening and into contact with an exterior of the cell phone case surrounding the existing built-in lens on the cell phone so that the attachable portable photographic lens secures the frame to the cell phone and the attachable portable photographic lens aligns with the existing built-in lens on the cell phone to produce a digital camera image modified by the attachable portable photographic lens.

3. The device of claim 2 wherein the two arms of the U-shaped frame a spaced apart by a distance greater than the width of the attachable lens cylinder and a cross member between the two arms of the frame has a threaded lens storage hole therein matching the threaded end of the attachable lens cylinder so that the attachable lens cylinder screws into the threaded lens storage hole for storing the attachable lens cylinder in the frame when not in use on the cell phone.

4. The device of claim 2 wherein the threaded end of the attachable lens cylinder has a padded edge for contact with the cell phone case.

5. The device of claim 1 wherein the attachable lens comprises a distance lens.

6. The device of claim 1 wherein the attachable lens comprises a telephoto lens.

7. The device of claim 1 wherein the attachable lens comprises a close-up lens.

8. The device of claim 1 wherein the attachable lens comprises an adjustable focus lens to focus the image over a range of distances.

9. The device of claim 1 wherein the attachable lens comprises a photographic filter.
